(19) United States
(12) Patent Application Publication
(10) Pub. No.: US 2009/0200044 A1
(43) Pub. Date: Aug. 13, 2009

(54) Rooftop water sprinkler

(76) Inventor: Timothy S. Durkin, Sacramento, CA (US)

Correspondence Address: TIMOTHY DURKIN, 7718 WHISPERING PALMS DR., SACRAMENTO, CA, 95823, US

(21) Appl. No.: 12/012,987

(22) Filed: Feb. 7, 2008

(51) Int. Cl. A62C 3/00; A62C 35/58; B05B 15/06

(52) U.S. Cl. 169/16; 169/54; 239/209

(57) ABSTRACT

Rooftop water sprinkler with a water sprinkler head, a pair rectangular frames, a pair of weight enclosing housings, a pair of hinge members and a straight water pipe. The water hose pipe is located between the rectangular frames. The hinge members are each comprised of three short tubular portions that form a triangular configuration. The water pipe is attached within the topmost tubular portion of the hinge member and a leg of each rectangular frame is attached to the bottom tubular hinge members. The sprinkler head is mounted mid way along the rigid water pipe. The water pipe terminates at one end in a garden hose fitting and at its opposite end in an a closure cap. The weight enclosing housings attach to the free portion of each of the rectangular frames. The frames straddle a roof ridgeline.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of fire prevention accessories and more specifically to a rooftop water sprinkler.

The danger of house being damaged due to its close proximity to a nearby forest fire is well known. Residents of homes in forested areas are told by local officials to cut down shrubbery and trees within a certain radius of their homes. However, because of the combination of fire and wind gusts, homes may be susceptible to the dangers of fire due to flying embers and other ignited debris.

Some individual have tried to solve the problem of destruction of a home by forest fire by mounting a sprinkler system on the roof of a house or trailer. These include patents U.S. Pat. No. 4,091,876, U.S. Pat. No. 6,450,264, U.S. Pat. No. 6,629,569, U.S. Pat. No. 6,679,337 and Design Pat. D542,886.

U.S. Pat. No. 4,091,876 shows multiple sprinklers permanently installed on a house trailer. All the additional patents show other fixed sprinkler devices, some with their own dedicated water tanks.

However, there is a deficiency in the prior technology in that none of the prior designs allows the user to easily and quickly install an inexpensive portable sprinkler device that sits securely on the ridge of a roof and can be used singly or in plurality to protect a roof from fire.

### BRIEF SUMMARY OF THE INVENTION

The primary object of the invention is to provide a rooftop water sprinkler that can be installed by a home owner when the threat of fire is present.

Another object of the invention is to provide a rooftop water sprinkler that is light weight and portable.

Another object of the invention is to provide a rooftop water sprinkler that will remain on the ridgeline of a roof even during strong winds.

A further object of the invention is to provide a rooftop water sprinkler that can connect with other similar sprinklers along a roof ridgeline to accommodate larger roofs.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Rooftop water sprinkler comprising: a water sprinkler head, a left and right hand pair rectangular frames formed of rigid pipe having a tubular cross section, a pair of weight enclosing housings, a pair of hinge members, a straight, rigid, tubular cross section water pipe, a standard garden hose fitting, a standard water pipe end cap, said water hose pipe located parallel to and closely adjacent to one long side tube member of each of the said rectangular frames, said hinge members each comprised of three short tubular portions whose sides are fastened to each other to form a triangular end view configuration, said water pipe fixedly attached within the topmost tubular portion of each said hinge member, said long side tube member of said right hand rigid tubular frame slidably attached within the lower right tubular portion of each said hinge member, said long side tube member of said left hand rigid tubular frame slidably attached within the left tubular portion of each said hinge member, said sprinkler head mounted in a standard fashion, facing up, mid way along said rigid water pipe, said water pipe terminating at one end in said garden hose fitting, said water pipe terminating at its opposite end in a standard end cap, said weight enclosing housings each attached to the free long leg of each of the said rectangular frames.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention in the use position.

FIG. 2 is a perspective view of the invention in the stored position.

FIG. 3 is a section view of the hinge portion of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

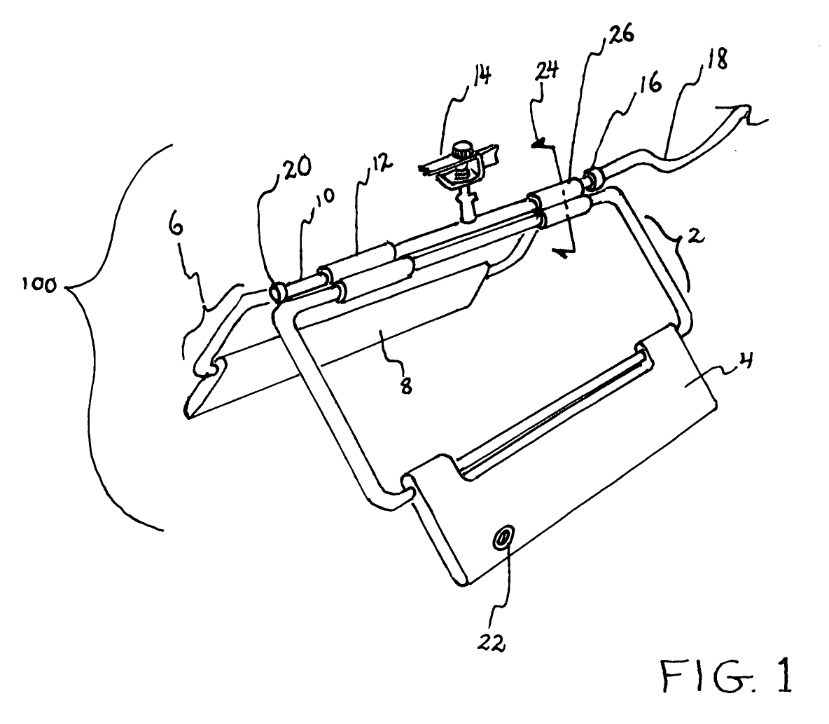

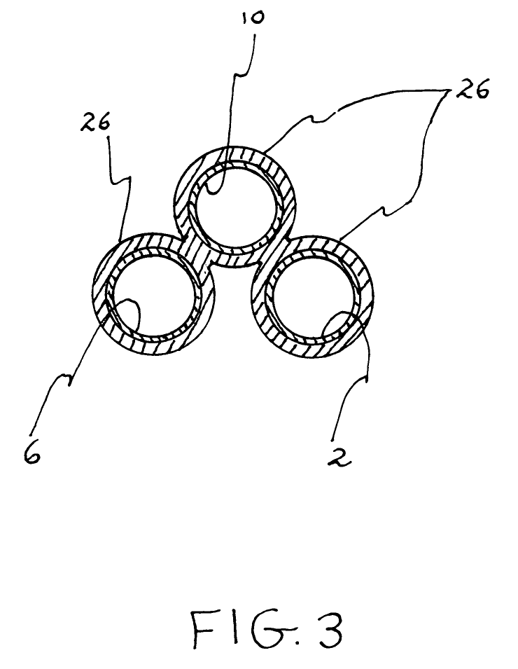

Referring now to FIG. 1 we see a perspective view of the invention 100 in its use position. In this configuration the invention 100 is ready to be put on top of a ridge portion of the roof of a person's home. A left and right pair of rectangular frame members 2, 6 are hingedly attached to each other by means of hinge members 12, 26. Hinge members 12, 26 contain an additional tubular portion that fixedly retains a rigid water tube 10. Water tube 10 terminates at one end in a female garden hose fitting 16 that can accept a standard garden hose 18, and at the opposite end in a closure cap 20. The hinge members 12, 24 have a triangular cross section as will be shown by section view in FIG. 3 as indicated by section line 24. Mid way along water tube 10 is fixed a standard sprinkler spray head 14 which is oriented in an upward or skyward position. Attached to the free long sides of each rectangular frame 2, 6 are a pair of hollow housings 4, 8 that can be filled with material such as water or sand so that the hollow housings 4, 8 become weighted and thereby help hold the rest of the rectangular frame assembly in place even during strong winds. Closure cap 22 can be removed for filling and then be replaced. The entire invention 100 is intended to sit on the ridge of the roof of a house. Because the rectangular frame members 2, 6 are hinged, they can accommodate a roof of any pitch. Water hose 18 can be connected at its opposite end to the nearest convenient water spigot outlet. Alternately, the user can unscrew the end cap 20 and replace it with a threaded garden hose fitting so that multiple units 100 can be attached to each other for covering a broader roof surface area. The user can install the invention 100 quickly when he or she gets word of an impending fire. The invention 100 can remain in operation even after a home owner has been ordered to evacuate the area.

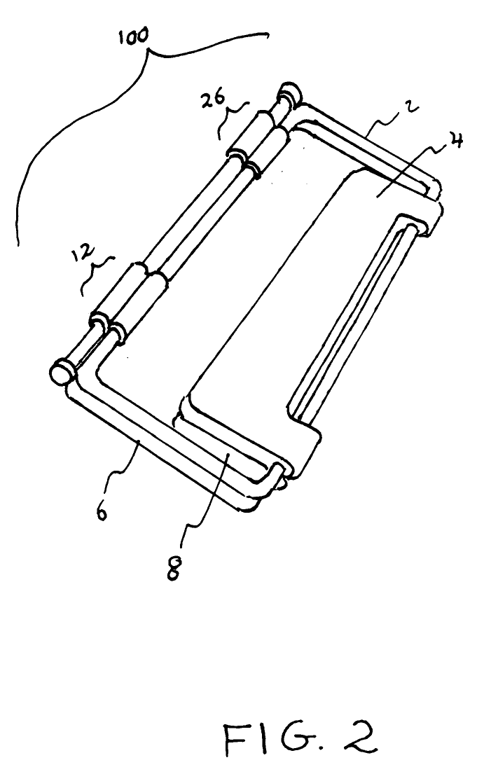

FIG. 2 shows a perspective view of the invention 100 in the closed or stored position. The weight holding housings 4, 8 are folded inward and the rectangular frames 2, 6 are folded so that one frame lies on top of the other. This configuration allows the invention to take up minimum shipping and storage space when not in use. Additionally, the hollow weight enclosing housings can be shipped empty to reduce shipping weight and can then be filled by the user.

An alternate embodiment is envisioned where the tubular rectangular frames are filled with weighted material such as sand or lead shot thereby eliminating the need for the additional hollow, weight containing housings.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Rooftop water sprinkler comprising:
a water sprinkler head;
a left and right hand pair rectangular frames formed of rigid pipe having a tubular cross section;
a pair of weight enclosing housings;
a pair of hinge members;
a straight, rigid, tubular cross section water pipe;
a standard garden hose fitting;
a standard water pipe end cap;
said water hose pipe located parallel to and closely adjacent to one long side tube member of each of the said rectangular frames;
said hinge members each comprised of three short tubular portions whose sides are fastened to each other to form a triangular end view configuration;
said water pipe fixedly attached within the topmost tubular portion of each said hinge member;
said long side tube member of said right hand rigid tubular frame slidably attached within the lower right tubular portion of each said hinge member;
said long side tube member of said left hand rigid tubular frame slidably attached within the left tubular portion of each said hinge member
said sprinkler head mounted in a standard fashion, facing up, mid way along said rigid water pipe;
said water pipe terminating at one end in said garden hose fitting;
said water pipe terminating at its opposite end in a standard said end cap;
said weight enclosing housings each attached to the free long leg of each of the said rectangular frames;

2. Rooftop water sprinkler as claimed in claim 1 wherein said weight enclosing housings are made of blow molded plastic and filled, by the user, with water.

3. Rooftop water sprinkler as claimed in claim 1 wherein said weight enclosing housings are filled with sand.

4. Rooftop water sprinkler as claimed in claim 1 wherein an alternate embodiment includes the said right and left hand frames are filled with lead shot an no separate said weight enclosing housings are required.

5. Rooftop water sprinkler as claimed in claim 1 wherein said sprinkler head is a clicker type head.

6. Rooftop water sprinkler as claimed in claim 1 wherein a standard garden hose fitting can be substituted for said water pipe end cap so that multiple rooftop water sprinkler units can be linked together by lengths of garden hose along the ridgeline of a roof.
